(19) United States
(12) Patent Application Publication
(10) Pub. No.: US 2026/0004560 A1
(43) Pub. Date: Jan. 1, 2026

(54) AUTOMATED SKILL DEVELOPMENT FROM VISUAL CONTENT

(71) Applicant: Zoho Corporation Private Limited, Kanchipuram District (IN)

(72) Inventors: Jeri John Prabhu Devageorge, Kanniyakumari (IN); Manikandan Vembu, Chennai (IN)

(73) Assignee: Zoho Corporation Private Limited, Kanchipuram District, TN (IN)

(21) Appl. No.: 19/046,431

(22) Filed: Feb. 5, 2025

Related U.S. Application Data
(60) Provisional application No. 63/681,336, filed on Aug. 9, 2024.

(30) Foreign Application Priority Data
Jun. 27, 2024 (IN) 202441049437

(51) Int. Cl. G06V 10/764; G06F 16/955; G06V 10/26; G06V 10/72; G06V 10/82; G06V 30/19

(52) U.S. Cl. CPC G06V 10/764; G06F 16/9566; G06V 10/26; G06V 10/72; G06V 10/82; G06V 30/19173

(57) ABSTRACT

Disclosed are methods and systems for automatically developing skills for intelligent personal assistants from visual content found on the internet. The disclosed system comprises components that crawl the web to discover and download images and videos, preprocess and analyze the content using computer vision and machine learning algorithms, classify and qualify the objects detected in the content, and create or enhance skills based on the analyzed data. The skills are then stored in a database and can be invoked by users via various client devices. The methods and systems simplify user interactions with web resources by automating the skill development process, enabling more efficient and personalized use of intelligent personal assistants.

### CROSS REFERENCE TO RELATED APPLICATION

This application claims the benefit of U.S. provisional application No. 63/681,336 filed 9 Aug. 2024 and entitled “Automated Skill Development from Visual Content,” by Devageorge and Vembu, which is incorporated herein by reference.

### BACKGROUND

This document describes methods for automatically creating “skills,” device capabilities in this context. Amazon's ALEXA, an intelligent personal assistant capable of voice interaction, provides examples in which a user can enable and disable skills, using the ALEXA application (app) or a web browser, as one would install and remove apps on a mobile device. Zoho, the assignee of the instant application, has an intelligent personal assistant called Zia. Some skills are detailed in U.S. Pat. No. 11,294,975 entitled “Systems and Methods for Automated Skill Creation and Selection,” which issued on 5 Apr. 2022 to Devageorge et al. and is incorporated herein by reference.

Skills can be called up using manual user-interface (UI) devices, such as a keyboard or mouse, or can be called up using voice commands. People and institutions are rapidly developing skills for accomplishing myriad tasks. There nevertheless remains a demand for skill development.

### SUMMARY

This document details methods and systems for extending the capabilities of computing devices communicatively coupled to the Internet. The system maintains a skills database and automatically browses web resources identified by Universal Resource Locators (URLs) to develop new skills. For each URL, the system searches for images, identifies objects within those images, classifies the objects to provide labels, and creates skill information relating to these labels. This skill information is then added to the skills database. The system can also recognize characters in the images and relate them to the labels, ensuring that both images and videos are processed effectively. Machine learning algorithms are leveraged to classify and qualify visual content, allowing for the automated creation and enhancement of skills that simplify user interactions with web resources.

### BRIEF DESCRIPTION OF THE DRAWINGS

FIG. 1 depicts the information flow in the system for automated skill development from visual content.

FIG. 2 illustrates a networked communication system that allows a user to access skills via a mobile device connected to a skills invocation engine and skills database over a wide-area network.

FIG. 3 (Prior Art) shows a general-purpose computing system that can serve as a client or server within the system.

The illustrations are by way of example, and not by way of limitation. Like reference numerals reference the same or similar elements.

### DETAILED DESCRIPTION

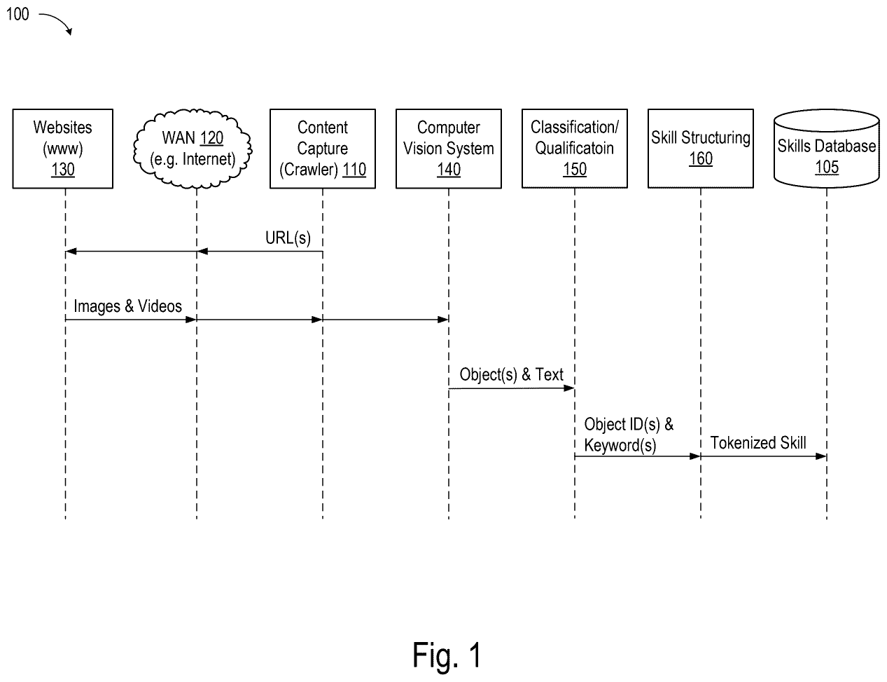

FIG. 1 diagrammatically depicts information flow 100 in support of systems and methods for extending the capabilities of client devices that are communicatively coupled to the Internet and capable of executing supported applications. The flow is automated to locate information resources on the World Wide Web (“web resources”) that require user interactions, develop skills in support of those interactions, and load the skills into a skills database 105. The skills thus developed and stored can simplify subsequent user interactions with the related web resources. For example, an automated skills-creation system might comb the web for restaurant menu cards, process the text and images, and develop skills for finding the depicted entrees. A user might afterward invoke a skill for finding Greek food or restaurants serving slow-cooked meat, a skill that might include helpful information like pricing and when these dishes are served. Skills development of this kind can expand to support interaction with a nearly unlimited number of service providers. The resultant ease of use would be a boon for mobile-device users.

Information flow 100 relies on components that can be supported by different economic entities (e.g., one or more cloud-based service providers interconnected via the Internet). A content-capture unit 110 with a web crawler service crawls the World Wide Web 120 in a methodical, automated manner to discover images and video on web pages 130. Content-capture unit 110 can select specific types of images and video, food or hardware for example, to emphasize popular skill types and reduce risks associated with malicious websites. Content-capture unit 110 can target skill creation by popularity rather than or in addition to via crawling. The latter is advantageous, however, in that skills can be created in advance of user access. Skills database 105 is periodically updated by re-crawling websites 130 to include new and updated visual content.

The web crawler of unit 110 uses an HTML processor running a headless browser (a web browser without a graphical user interface) to access images and video via their uniform resource locators (URLs), issuing requests to download images and videos from websites 130. Content-capture unit 110 downloads the images and video and conveys them to a computer vision system 140. The following discussion focuses on images for simplicity but can be extended to videos or frames of videos.

Vision system 140 preprocesses images to remove noise or artifacts or otherwise adjust image properties. The preprocessed image is tokenized and then analyzed to identify key features, such as edges, corners, and patterns. This information is then used to create a simplified representation of the image that can be more easily processed. Next, a neural processing unit (NPU) may divide the image into smaller, more manageable segments. This allows the NPU to focus on specific areas of the image and extract more detailed information. The features thus detected are conveyed to a classification/qualification unit 150 that applies machine learning algorithms to recognize text and identify and classify objects from the image. Object classification can include segmenting an image into multiple regions and analyzing each region individually.

Image qualification refers to a process of determining whether classified objects meet certain criteria or standards, such as whether they are of a type relevant to the creation of a desired skill and assigning object identifiers (IDs) and keywords to the relevant types. The object IDs and keywords are then passed to a skill-structuring unit 160 that creates or enhances a skill eliciting a conversational phrase that calls upon the objects of the object IDs and keywords. The new or modified skill is then stored in skills database 105 to be called upon at a later time. For example, a skill for having Mediterranean food delivered might be updated to include information extracted from a website, including object data extracted from images or video.

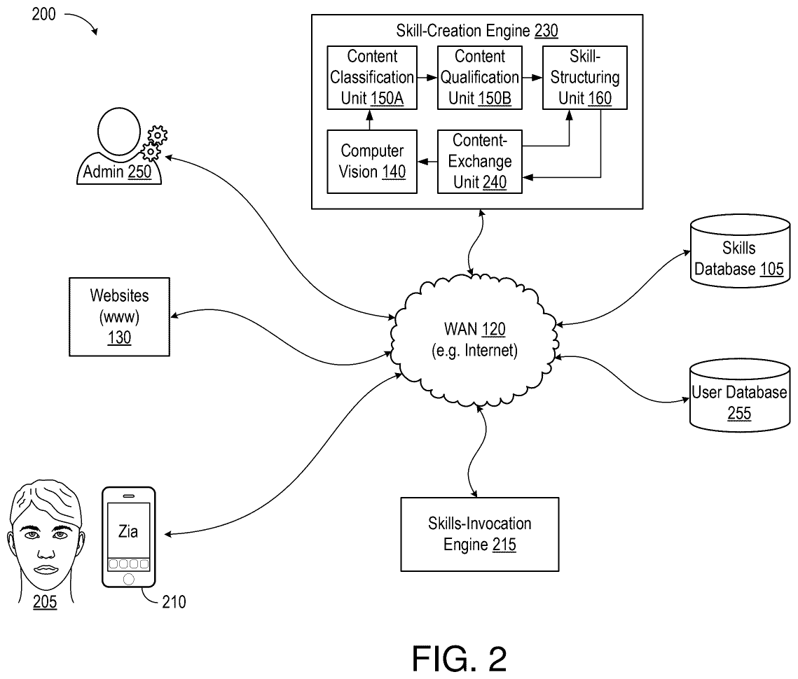

FIG. 2 depicts a networked communication system 200 that allows a user 205 access to skills using a mobile device 210 communicatively connected to a skills invocation engine 215 with access to skills database 105. These devices are interconnected via wide-area network 120. A skills-creation engine 230, components of which are introduced in FIG. 1, has or has access to skills database 105. Engine 230 additionally supports or includes a content-exchange unit 240 with capture unit 110 (FIG. 1) and means for passing skills to database 105. Content classification/qualification unit 150 is divided into units 150A and 150B. An administrative controller 250, e.g. a human operator or an automated admin bot, initiates the crawler within content-exchange unit 240 of skill-creation engine 230 to crawl through websites 130. Device 210, a mobile phone in this example, can be other types of client devices that support text and voice user interfaces and have access to networked resources.

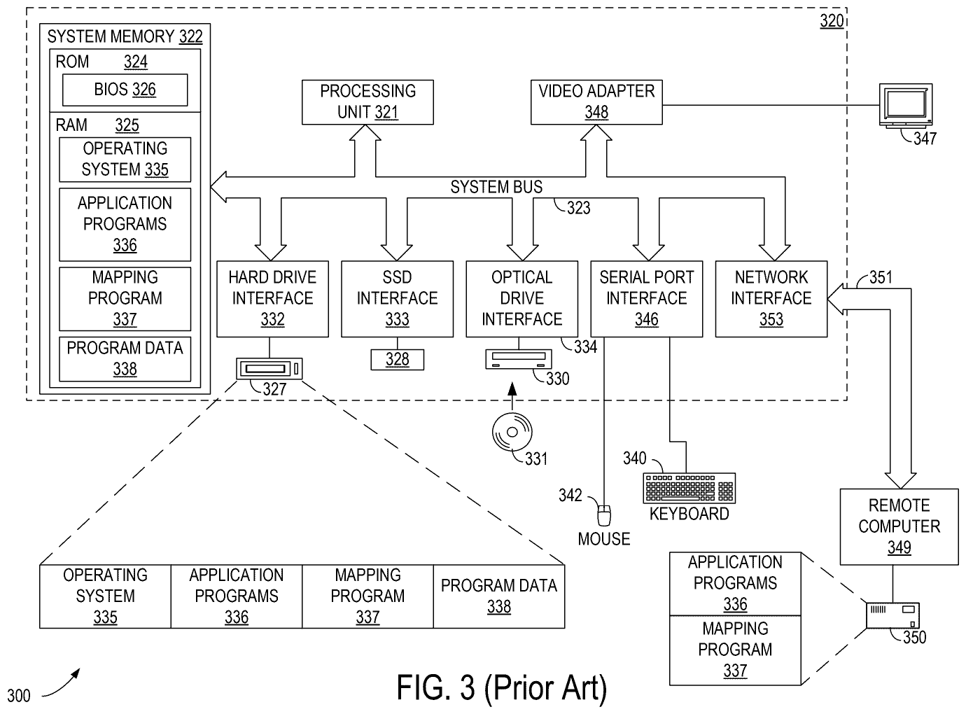

Skill-creation engine 230 is implemented on one or more computers, an example of which is provided below in connection with FIG. 3 (prior art). This computer or computers implements a method for extending the capabilities of mobile computing device 210. Skill-creation engine 230 is communicatively coupled to network 120 and is capable of executing instructions responsive to input from administrative user 205. These instructions create, maintain, and extend skills, or capabilities, in skills database 105. To extend the skills, content exchange unit 240 browses resources identified by URLs and searches for visual content, such as images that may include depictions of products or services. Images and videos in HTML are identified using the <img> and <video> tags, respectively. These tags provide browsers with the necessary information to display the multimedia content on a webpage. Unit 240 can examine tags to extract information relating to the image. For instance, the <img> tag uses the src attribute to specify the source of the image, like this:
html
   <img src=“my-image.jpg” alt=“A description of the image”>

The <video> tag, on the other hand, can have multiple <source> tags nested within it to provide different video formats or resolutions. This flexibility allows browsers to choose the best option based on browser capabilities.

Images and video are passed to computer-vision unit 140, which extracts features such as shapes, edges, textures, and patterns. Content-classification unit 150A uses the extracted features to detect and classify depicted objects. Content-qualification unit 150B filters images and videos to exclude low-quality, irrelevant, inappropriate, or offensive objects from consideration, passing on suitable objects to skill-structuring unit 160.

Skill-structuring unit 160 relates images with classified objects to other information collected by content-exchange unit 240 from the URL or a family of URLs from which the image was downloaded. A website with images of cars might also describe a car dealership with model information, pricing, hours of operation, location, contact information, etc. Skill-structuring unit 160 employs image and website data from units 150B and 240 to build or extend skills for e.g. searching for cars. Skills-invocation Engine 215 has access to database 105 and can be called upon by a user of system 200. Using the example of a car dealership, user 205 may use device 210 to invoke a skill to find a car of interest; “Zia: find me a red convertible for under fifty-thousand dollars within ten miles of my location.” System 200 should respond with any such cars and relevant information, such as location and price. Skills-invocation engine 215 can include a recommendation engine with access to user database 255 to tailor user responses based on e.g. the user's age, income, location, interests, interaction history, and preferences.

Image-based skill acquisition has advantages over text-based skill acquisition. Fans of slow-cooked meat might enjoy Mexican barbacoa, Jewish brisket, Indonesian rendang, American pulled pork, or Brazilian feijoada. An image-based skill with the capacity to “find a restaurant serving slow-cooked meat” might return any of these possibilities without regard to the labeling of the dishes on their respective websites. Skill-invocation engine 215 can respond with the requested entrees and other relevant information like pricing, location, and availability. The image source, such as a menu, can also be stored in skills database 105 and presented to user 205 responsive to a skill invocation.

System 200 can be used to develop skills from captured or live video. For example, a webpage can include an embedded live video of a scene that includes an object of interest, such as a celebrity or a rocket. Skill-creation engine 230 can detect and classify such an object as noted previously and supplement the classified object with data and metadata, such as the filming location, weather, activity, and pricing. These data can then be used to create or modify a skill in database 105. For example, a skill can be called upon to supplement a live view of a rocket launch with a user-interface element, such as a link, to view a launch or tour schedule, an invitation to join a fan group, or other nearby attractions.

Skill-creation engine 230 could recognize, classify, and qualify video and images of activities so that skill-structuring unit 160 can structure an “activity” skill that could be invoked by users interested in an activity. A user viewing a video of sailing, for example, could invoke an activity skill thusly: “Zia, I want to do this.” Skills invocation engine 215 could then follow a skill in database 105 to interact with the user to set up a sailing adventure. Automatic skill development would periodically supplement the “activity” skill with information gleaned by browsing Internet resources for embedded images, videos, and video streams so the activity skill would stay current.

FIG. 3 (prior art) depicts a general-purpose computing system 300 that can serve as a client or a server depending on the program modules and components included. One or more computers of the type depicted in computing system 300 can be configured to perform operations described with respect to FIGS. 1 through 4. Those skilled in the art will appreciate that the invention may be practiced using other system configurations, including hand-held devices, multiprocessor systems, microprocessor-based or programmable consumer electronics, network PCs, minicomputers, mainframe computers, and the like.

Computing system 300 includes a conventional computer 320, including a processing unit 321, a system memory 322, and a system bus 323 that couples various system components including the system memory to the processing unit 321. The system bus 323 may be any of several types of bus structures, including a memory bus or memory controller, a peripheral bus, and a local bus using any of a variety of bus architectures. The system memory includes read only memory (ROM) 324 and random-access memory (RAM) 325. A basic input/output system 326 (BIOS), containing the basic routines that help to transfer information between elements within the computer 320, such as during start-up, is stored in ROM 324. The computer 320 further includes a hard disk drive 327 for reading from and writing to a hard disk, not shown, a solid-state drive 328 (e.g. NAND flash memory), and an optical disk drive 330 for reading from or writing to an optical disk 331 (e.g., a CD or DVD). The hard disk drive 327 and optical disk drive 330 are connected to the system bus 323 by a hard disk drive interface 332 and an optical drive interface 334, respectively. The drives and their associated computer-readable media provide nonvolatile storage of computer readable instructions, data structures, program modules and other data for computer 320. Other types of computer-readable media can be used.

A number of program modules may be stored on the hard disk, solid state disk 328, optical disk 331, ROM 324 or RAM 325, including an operating system 335, one or more application programs 336, other program modules 337, and program data 338. A user may enter commands and information into the computer 320 through input devices such as a keyboard 340, microphone 341, and pointing device 342. Other input devices (not shown) may include a microphone, joystick, game pad, satellite dish, scanner, or the like. These and other input devices are often connected to the processing unit 321 through a serial port interface 346 that is coupled to the system bus, but may be connected by other interfaces, such as a parallel port, game port or a universal serial bus (USB). A monitor 347 or other type of display device is also connected to the system bus 323 via an interface, such as a video adapter 348. In addition to the monitor, computers can include or be connected to other peripheral devices (not shown), such as speakers and printers.

The computer 320 may operate in a networked environment using logical connections to one or more remote computers, such as a remote computer 349. The remote computer 349 may be another computer, a server, a router, a network PC, a peer device or other common network node, and typically includes many or all of the elements described above relative to the computer 320, although only a memory storage device 350 has been illustrated in FIG. 3. The logical connections depicted in FIG. 3 include a network connection 351, which can support a local area network (LAN) and/or a wide area network (WAN). Such networking environments are commonplace in offices, enterprise-wide computer networks, intranets and the Internet.

Computer 320 includes a network interface 353 to communicate with remote computer 349 via network connection 351. In a networked environment, program modules depicted relative to the computer 320, or portions thereof, may be stored in the remote memory storage device. The network connections shown are exemplary and other means of establishing a communication link between the computers may be used.

Variations of these embodiments, including embodiments in which features are used separately or in any combination, will be obvious to those of ordinary skill in the art. Therefore, the spirit and scope of the appended claims should not be limited to the foregoing description. In U.S. applications, only those claims specifically reciting “means for” or “step for” should be construed in the manner required under 35 U.S.C. section 112(f).

What is claimed is:

1. A computer-implemented method for extending capabilities of a computing device communicatively coupled to a wide-area network and capable of executing instructions, the method comprising:
maintaining a skills database of the capabilities;
automatically browsing resources identified by universal resource locators (URLs); and
for each of the URLs,
searching the resource identified by the URL for an image;
identifying an object within the image;
classifying the object to provide a label for the object;
creating skill information relating to the label;
associating the skill information with the URL; and
adding the skill information to the skills database.

2. The method of claim 1, further comprising:
recognizing characters in the image; and
relating the characters to the label.

3. The method of claim 1, wherein the image comprises at least one of an image file and a video file.

4. The method of claim 1, wherein the searching the resource identified by the URL for an image comprises scanning the resource for an image tag.

5. The method of claim 1, further comprising retrieving the image from the resource identified by the URL.

6. The method of claim 1, further comprising:
extracting metadata associated with the image; and
incorporating the metadata into the skill information.

7. The method of claim 1, wherein the classification of the object includes the use of a neural network to identify and label the object.

8. The method of claim 1, further comprising:
filtering the images to exclude irrelevant or low-quality images before identifying objects.

9. The method of claim 1, wherein the created skill information includes a conversational phrase associated with the identified object, enabling voice interaction with the skill.

10. The method of claim 1, wherein the skills database is periodically updated by re-crawling the resources to include new and updated visual content.

11. A system for extending capabilities of a computing device communicatively coupled to a wide-area network and capable of executing a plurality of supported applications, the system comprising:
one or more computers configured to perform operations including:
maintaining a skills database of the capabilities;
automatically browsing resources identified by universal resource locators (URLs); and
for each of the URLs,
searching the resource identified by the URL for an image;
identifying an object within the image;
classifying the object to provide a label for the object;
creating skill information relating to the label;
associating the skill information with the URL; and
adding the skill information to the skills database.

12. The system of claim 11, the operations including character recognition to recognize characters in the image.

13. The system of claim 12, wherein the image comprises at least one of an image file and a video file.

14. The system of claim 11, wherein the searching the resource identified by the URL for an image comprises scanning the resource for an image tag.

15. The system of claim 11, further comprising retrieving the image from the resource identified by the URL.

16. The system of claim 11, wherein the skills database is hosted on a cloud-based platform and is accessible by multiple client devices.

17. The system of claim 11, further comprising:
a recommendation engine that suggests skills to users based on their interaction history and preferences.

18. The system of claim 11, wherein classifying the object includes segmenting the image into multiple regions and analyzing each region individually.

19. The system of claim 11, further comprising generating a user interface element associated with the skill.
